(19) United States
(12) Patent Application Publication
(10) Pub. No.: US 2009/0173618 A1
(43) Pub. Date: Jul. 9, 2009

(54) Method of an apparatus for generating a vacuum and for separating volatile compounds in polycondensation reactions

(76) Inventor: Rudolf Kämpf, Gründau (DE)

Correspondence Address: K.F. ROSS P.C., 5683 RIVERDALE AVENUE, SUITE 203 BOX 900, BRONX, NY, 10471-0900, US

(21) Appl. No.: 11/918,811

(22) PCT Filed: Feb. 27, 2006
(86) PCT No.: PCT/EP2006/001768

§ 371 Date: Jan. 16, 2009

(30) Foreign Application Priority Data
Apr. 22, 2005 (DE) 10 2005 018 843.5

(51) Int. Cl. B01D 5/00; B01D 3/38

(52) U.S. Cl. 203/27; 203/65; 202/185.2

(57) ABSTRACT

The invention relates to a method for generating a vacuum and for separating volatile compounds during esterification, transesterification and/or polycondensation reactions. One or several jets of steam comprising a spray condenser, which is arranged up or downstream, are connected to the suction side of a reactor which is to be evacuated and phenol or steam containing phenol is used as propellant steam at a pressure of 0.5 hPa to approximately 1.5 MPa and liquid phenol or a liquid containing phenol is used as a spraying agent.

The invention relates to a method of and an apparatus for generating a vacuum and separating volatile compounds in transesterification, esterification, and/or polycondensation reactions, in particular in the preparation of polyesters, polyarylates, polyamides, polysulfones, polyether ketones, and polycarbonates, in which the suction side of the polycondensation reactor is connected to at least one steam jet vacuum pump having an attached spray condenser.

Polycondensates are widely used in machine manufacture, equipment, and electrical engineering, construction, the textile and paint industries, and for articles of everyday use due to their excellent mechanical and technical properties. They are produced either by interfacial condensation or melt polycondensation by direct polycondensation of dicarboxylic acids and diamines, dialcohols, or diphenols, or by transesterification of the corresponding acid esters. When melt polycondensation is used to produce polycarbonates, polyarylates, aromatic polyamides, or any other polymers containing aryl groups in the polymer structure, aromatic dihydroxy compounds, for example bis(4-hydroxyphenyl)alkanes, in particular bisphenol A, are transesterified with diphenyl carbonate or diarylalkyl phosphonates in the presence of catalysts with cleavage of phenol, oligomerized, and then subjected to polycondensation. The transesterification, esterification, and/or polycondensation is carried out in multiple reactor stages under increasing vacuum, for example starting with a light vacuum of 800 mbar, and setting a vacuum of <100 mbar for the precondensation and a vacuum of <1 mbar at a temperature of 220 to 350° C. for the end-stage polycondensation. Such methods are described in German patents DE-B-1 495 370 [U.S. Pat. No. 3,704,286] and DE-C-2 334 852 [U.S. Pat. No. 3,888,826].

Special measures are necessary to prepare blends of polycarbonates and/or polyarlyates and copolyesters by reacting phenyl esters of various monovalent, bivalent, trivalent, or polyvalent acids, since the resulting phenol has a melting point of 41° C., and deposition of solids may occur on unheated equipment parts at temperatures below this level. Extremely fine particles of monomer, oligomer, and polymer, which are contained primarily in the phenol-containing vapors drawn out from the reactors, promote the tendency for deposition on cold surfaces. For this reason special measures must be taken which are not necessary in the known technology for drawing off reaction vapors by use of steam jets. For example, either mechanical scrapers or blades must be attached which clean the affected wall surfaces on an occasional or continuous basis.

The polycondensation is generally carried out by reacting one or more monomers while adding a catalyst. After short-chain oligomers are produced at elevated pressures up to 100 mPa, atmospheric pressure, or even light vacuum up to 500 hPa, precondensation of medium-chain molecules is carried out under vacuum at pressures of less than 100 hPa, and in the end stage in which long-chain polymers are present, pressures of less than 1 hPa and temperatures of up to 350° C. are necessary.

The vacuum may be generated in a customary manner by use of mechanical pumps whose surface condensers are situated upstream or downstream for separation of condensable components in the vapors exiting the reactor and contained therein, which essentially comprise phenols, polyhydric alcohols, small quantities of other monomers, and traces of oligomers. It is disadvantageous that, according to the ideal gas law under high vacuum, the vapor volume is very high, and the equipment parts, in particular the mechanical vacuum pumps, must be designed for very large intake volumes. Individual pumps are not always available for the volumes of vapor to be withdrawn from the reactor, and multiple pumps must be provided side by side. In addition, the volatile, condensable components at correspondingly low condensation temperatures frequently result in operating downtime due to coating of the surface condensers with liquid and/or solid deposits and coating of the pump and piping system.

For this reason, the use of coolers equipped with rotating scrapers has previously been proposed for cleaning the cooling surfaces. Such coolers have the disadvantage that passages under vacuum are necessary which entails high risks for operation and product quality in the event of leaks. It is also known to generate the vacuum in the end stage of the polycondensation, while retaining a surface condenser, by using two steam-driven steam jet vacuum pumps provided one behind the other (SRI Report No. 50B (1982), Polycarbonates, FIG. 5.1). However, this creates a significant environmental problem, namely, the production of large quantities of wastewater contaminated with phenols, dialcohols, and oligomers, for example. In addition, oligomer deposits inside the steam jet result in malfunctions, since the condensate from the vapors released during the reaction is seldom completely mixed with water.

In the preparation of polyethylene terephthalate, it is also known to generate the vacuum for the final polycondensation by use of steam jets together with a downstream spray condenser, liquid ethylene glycol being used as spray liquid and ethylene glycol vapor at a pressure of approximately 2 bar being used as propellant vapor (U.S. Pat. No. 3,468,849, DE-A-2 227 261 [GB 1,382,095], and WO 2004/096893 A2 [US 2006/0247412]). Ethylene glycol is a liquid at room temperature, and at 2 bar boils at 222° C., whereas the monomer starting products and the released phenol-containing vapors from the preparation of polycarbonate, polyarylate, and copolymer from diphenols and phenyl esters of polyvalent acids are solids at room temperature. It is not uncommon for these compounds to have high boiling temperatures greater than 300° C. at atmospheric pressure, at which undesired decomposition products and side reactions sometimes occur. For the most part, however, phenol and/or vapors originating primarily from phenol or multivalent phenol occur which as cleavage products are cleaved from the monomer compounds and are present in liquid and/or solid form at standard conditions. Thus, phenol has a boiling point of 181.8° C. at standard pressure and a melting point of 40.8° C., and is a solid at ambient conditions.

The object of the present invention, therefore, is to provide a method for generating a vacuum and separating the volatile, condensable components of the vapors from a melt phase polycondensation, in particular the last stage of the polycondensation, for example the preparation of polycarbonate and polyarylate, which in comparison to the methods of the described prior art results in a reduction of the vapor volume and avoids operating malfunctions due to monomer and oligomer deposits. It is a further aim that no waste water contaminated with phenol or oligomers is generated, and the medium used as propellant vapor may also be used in the production of copolymers of polyesters from multivalent phenols, alcohols, amines, and multivalent organic and/or inorganic acid esters. In one preferred embodiment, at least one first vapor compression is carried out by means of condensation using steam jets operated with phenol-containing steam, and for increasing the energy yield a further, second compression is carried out by use of mechanical vacuum pumps.

This object is achieved according to the invention by use of a method for generating a vacuum and separating volatile compounds in polycondensation reactions, a reactor to be evacuated is connected on the suction side to one or more steam jets each attached to a spray condenser situated upstream or downstream, and phenol or steam containing phenol at a pressure of 0.5 hPa to approximately 1.5 MPa is used as propellant vapor, and liquid phenol or a liquid-containing phenol is used as spraying agent.

In this method, at least bivalent phenols, alcohols, and/or amines and at least bivalent acids and/or the phenol-containing esters thereof are used in the polycondensation reaction. According to the invention, the polycondensation reaction is preferably carried out as a multistage melt phase polycondensation, and the reactor to be evacuated is the last or one of the last in the series of polycondensation reactors in which the method is carried out.

Surprisingly, it has been found that the phenol released in this reaction, despite its melting temperature of approximately 40.8° C. and boiling temperature of approximately 182° C. at 1 bar, is very well suited as a propellant vapor for a vacuum-generating steam jet, and as a spray liquid for spray condensation of the high-boiling components in vapors. It has also been unexpectedly found that in the presence of other entrained monomers the phenol has a tendency toward supercooling, and does not begin to solidify until temperatures well below its melting point are reached. It is thus possible to use phenol in vacuum generation systems, and to keep the vacuum-generating units and lines free of deposits simply by heating with warm water. It has been found that phenol is able to dissolve large quantities (up to 25%) of entrained monomers and oligomers and to keep these in the liquid phase without deposition on the walls of the equipment.

The propellant vapor used for a steam jet preferably has a pressure in the range of 0.3 hPa to approximately 1.5 MPa. Higher pressures are preferred from the standpoint of energy efficiency. Depending on the dimensions of the unit, however, a procedure that is thermally milder, corresponding to a propellant vapor pressure in the range of 5 hPa to 0.1 MPa, may be necessary.

FIG. 1 shows one design of the method according to the invention having only steam jets 6, which is particularly advantageous when the produced product and the volatile monomers tend toward particularly heavy deposits of solid and/or viscous condensates and these materials are further transported through the vapor or condensate stream. At higher propellant vapor pressures one steam jet per stage is usually sufficient, whereas at low propellant vapor pressures it is advisable to provide two steam jets upstream in conjunction with a spray condenser 7. To ensure that any condensation in the region of the steam jet, in particular at low propellant vapor pressures, is excluded, the phenol vapor 5 may be superheated between the steam generator and the steam jet by 1 to 100° C., preferably by 3 to 25° C. The vaporous mixture, containing phenol and other volatile compounds from the polycondensation as well as oligomers or monomers contained in the vapors, exiting the steam jet(s) 6 is led into a directly adjoining spray condenser 7, in which the condensable components are separated by spraying with liquid condensate 14, reprocessed phenol 19, and fresh phenol. To achieve maximum separation the temperature of the spray liquid must be as low as possible. Depending on the purity of the liquid fed in, selection of a temperature in the range of 10 to 200° C., preferably 40 to 120° C., is recommended.

The condensate flowing from the spray condenser 7 is preferably collected in individual receivers 23 and 24, a portion of the condensate being circulated as spray liquid 14 with appropriate temperature equilibration, and another portion being fed to an evaporator 17 for producing the propellant vapor 5. The remaining, excess portion of the condensate is discharged from the steam jet-spray condenser unit and returned to the phenol evaporator 17 within the process and/or to a recovery unit 19. At the same time, accumulation of oligomers, monomers, and phenols, for example, in the condensate is thus avoided. The condensates from multiple spray condensers may be combined in a collection container 23, 24 before being divided into substreams.

Upon exiting the first spray condenser, the pressure of the uncondensed vapor phase is higher, depending on the compression ratio of the steam jet(s) upstream, than that of the polycondensation reactor. The further compression may occur in additional analogous phenol vapor jets and/or phenol spray condenser stages, or also by means of mechanical vacuum pumps, as shown in FIG. 2. However, the further compression may initially occur in one to three additional steam jet-spray condenser units, and then may be performed using at least one mechanical vacuum pump 26.

In this context, “mechanical vacuum pump” is understood to mean, for example, a vacuum blower system, membrane pump system, and/or liquid ring pump system 26 having a condenser 13. Condensate from the condensers or pure phenol may be used as operating liquid for the liquid ring pump. If needed, heat exchangers and/or additional condensers may be connected in-between. At the same time, these additional compression stages may generate the vacuum for the preceding transesterification, esterification, and/or polycondensation stages.

The connection of multiple steam jets 6 is energy-intensive and characterized by low efficiency, and is meaningful only in the cases described above. As the result of using mechanical blowers 8, 10, 12, the method illustrated in FIG. 2 does not have the disadvantage of low efficiency. In this case the risk of blockage and/or malfunction of the mechanical blowers 8, 10, 12 due to deposits of entrained particles or precipitated condensates is advantageously avoided by providing vapor compression by means of steam jets 6 and spray condensers 7 upstream.

Surprisingly, it has been found that a method for generating a vacuum operates in a particularly economical and reliable manner when, in addition to one or more steam jet-spray condenser units, a mechanical vacuum pump is used for generating a vacuum, by means of which vapor compression 6, 7 takes place. By use of this method, the energy consumption may be reduced by more than half compared to vacuum generation solely by means of steam jets. The operational reliability is maintained, since the susceptibility of a first vapor compression to thermal stress and entrained particles as the result of mechanical blowers may be avoided.

When multistage steam jets and vacuum pumps are used, these may also be used to simultaneously generate the vacuum for a first reaction stage and/or precondensation, whereby substreams of the condensate from the spray condensers 7, 9, 11, 13 are collected in a separate container 24 and used separately in an evaporator 17 for producing the propellant vapor for the steam jet 6. The evaporator 17 may also be operated only with pure phenol with recycling of condensate 14. The operating pressure of the evaporator is slightly higher, corresponding to the pressure drop in the pipelines and fittings, than the desired propellant vapor pressure. In other respects, the evaporator, including customary supplementary units, is operated in the manner described. For multiple steam jet stages, the phenol vapor obtained from the evaporator is divided into a corresponding number of substreams. The evaporator sump is continuously and partially discharged, and optionally reused. In this regard it has proven to be particularly advantageous that the monomers, cleavage products, and volatile oligomers entrained in the vapors have a much higher boiling point than the phenol used, and may therefore be concentrated in the evaporator 17.

In the method according to the invention it is advantageous for the spray liquid to have a temperature of 10 to 200° C.

Furthermore, the method may be carried out in equipment and lines which have been warmed by a heating medium having a temperature of at least 20° C. The temperature of the heating medium may preferably be 20-125° C., particularly preferably 25-100° C. As a result of these low temperatures, the heating system may be designed in a simple manner and operated at low cost by using warm water, for example.

The invention further relates to an apparatus for generating a vacuum and separating volatile compounds from polycondensation reactions, in which the reactor to be evacuated is connected on the suction side to one or more steam jets, each having a spray condenser situated upstream or downstream, in which phenol or steam containing phenol may be used as propellant vapor at a pressure of 0.5 hPa to approximately 1.5 MPa, and liquid phenol or a liquid-containing phenol is used as spraying agent. It is particularly advantageous when, in addition to one or more steam jet-spray condenser units, a mechanical vacuum pump is present for generating a vacuum. This mechanical vacuum pump comprises a pump and a condenser.

The claimed method according to the invention and the associated apparatus allow malfunction-free and economical generation of the vacuum for one or more polycondensation reactions in the preparation of polycarbonate and polyester copolymers according to the melt process, using bivalent phenols, alcohols, and/or amines and at least bivalent acids and/or the phenol-containing esters thereof.

Operating downtime as the result of monomer and/or oligomer deposits or saturation of surface condensers is practically eliminated. All valuable materials are recirculated within the process. Waste emissions are reduced to a minimum, since the exhaust gas from the last compressor is sent to incineration 16. As a result of the closed circuit, there is no generation of wastewater contaminated with phenols, oligomers, and monomers.

### LIST OF REFERENCE NUMERALS

1 Reactor
2 Product inlet, addition of monomer
3 Product outlet
4 Vacuum
5 Phenol vapor
6 First vapor compressor, steam jet
7 Condenser, spray condenser
8 Mechanical blower
9 Condensate separator, cooler, spray condenser
10 Mechanical blower
11 Separator
12 Mechanical blower, screw compressor
13 Cooler, condenser
14 Condensate circuit
15 Exhaust gas
16 Incineration
17 Phenol evaporator
18 Discharge
19 Phenol and condensate reprocessing
20 Supplementary heater
21 Heat transfer medium feed
22 Heat transfer medium return
23 Condensate collection container
24 Condensate collection container
25 Recycle pump
26 Intermediate vacuum
27 Intermediate vacuum

1-13. (canceled)

14. A method for generating a vacuum and separating volatile compounds in transesterification, esterification, and/or polycondensation reactions wherein the reactor to be evacuated is connected on the suction side to one or more steam jets each attached to a spray condenser situated upstream or downstream and to at least one mechanical vacuum pump, and phenol or a vapor containing at least 75% phenol at a pressure of 0.5 hPa to approximately 1.5 MPa is used as propellant vapor, and liquid phenol or a liquid-containing phenol is used as spraying agent.

15. The method defined in claim 14 wherein at least bivalent phenols, alcohols, and/or amines and at least bivalent acids and/or the phenol-containing esters thereof are used in the transesterification, esterification, and/or polycondensation reaction.

16. The method defined in claim 14 wherein the polycondensation reaction is carried out as a multistage melt phase polycondensation.

17. The method defined in claim 14 wherein the liquid composed of or containing phenol which flows from the spray condenser(s) is supplied completely to an evaporator for producing the propellant vapor, or a portion thereof is supplied to an evaporator for producing the propellant vapor and a portion is supplied to a recovery unit.

18. The method defined in claim 14 wherein the phenol vapor has a pressure of approximately 0.5 hPa to 1.5 MPa.

19. The method defined in claim 14 wherein before entry into the steam jet the propellant vapor is superheated by 1 to 100° C.

20. The method defined in claim 14 wherein the spray liquid has a temperature of approximately 10 to 200° C.

21. The method defined in claim 14 wherein a unit comprising a pump and a condenser is used as a mechanical vacuum pump.

22. The method defined in claim 14 wherein the method is carried out in equipment and lines which are warmed by a heating medium at a temperature of 20° C., preferably 20-125° C., particularly preferably 25-100° C.

23. An apparatus for generating a vacuum and separating volatile compounds in polycondensation reactions wherein the reactor to be evacuated is connected on the suction side to one or more steam jets each attached to a spray condenser situated upstream or downstream, and at least one mechanical vacuum pump is provided in which phenol or steam containing phenol is used as propellant vapor, and liquid phenol or a liquid-containing phenol is used as spraying agent, and the vacuum-generating equipment and lines may be kept free of deposits by heating.

24. An apparatus defined in claim 23 wherein in addition to one or more steam jet-spray condenser units at least one mechanical vacuum pump is present for generating a vacuum.

25. The apparatus defined in claim 23 wherein a unit comprising a pump and a condenser is the mechanical vacuum pump.
